(19) United States
(12) Patent Application Publication
(10) Pub. No.: US 2018/0022300 A1
(43) Pub. Date: Jan. 25, 2018

(54) SYSTEM FOR SUPPLYING ELECTRIC POWER TO THE ELECTRICAL EQUIPMENT OF A MOTOR VEHICLE BY A HIGH-PERFORMANCE BATTERY, CORRESPONDING CURRENT LIMITATION DEVICE AND STARTER PROVIDED

(71) Applicant: VALEO EQUIPEMENTS ELECTRIQUES MOTEUR, Creteil Cedex (FR)

(72) Inventor: Nicolas LABBE, Lyon (FR)

(21) Appl. No.: 15/549,263

(22) PCT Filed: Jan. 29, 2016
(86) PCT No.: PCT/FR2016/050199

§ 371 Date: Aug. 7, 2017

(30) Foreign Application Priority Data
Feb. 10, 2015 (FR) 1551052

(51) Int. Cl. B60R 16/033

(52) U.S. Cl. CPC B60R 16/033

(57) ABSTRACT

The invention relates to a system for supplying electric power (10) to electrical equipment via a high-performance battery (2) comprising at least one device (LPF) for limiting a current of the high-performance battery. The high-performance battery has a first nominal voltage greater than that of a standard battery initially provided for supplying the equipment, which include an internal combustion engine starter (8) that is connected to the high-performance battery via the limiting device. According to the invention, the limiting device (LPF) is a transformer having a secondary winding circuit (R, W2) formed by a short-circuited secondary winding (W2). According to another feature, the coupling coefficient of the transformer and a secondary resistance of the secondary winding circuit are dependent on the specific characteristics of the equipment.

### TECHNICAL FIELD OF THE INVENTION

In general, the invention relates to a system for supplying electric power to the electrical equipment of a motor vehicle by a high performance battery, and a corresponding current limitation device.

More particularly, the invention relates to the combination of a standard starter which is designed for use with a standard battery of the lead-acid type, and a limitation device which allows power to be supplied to this standard starter by a battery of the lithium-ion type.

### TECHNOLOGICAL BACKGROUND OF THE INVENTION

When power is supplied to a starter in order to ensure the starting of the thermal engine of the vehicle, a substantial requirement for current occurs, which is close to the short-circuit current of the starter, i.e. a current of approximately 1000 A. This current requirement when power is supplied to the starter then decreases in intensity as the speed of the armature of the starter, corresponding to the rotor of the machine, increases.

This initial current spike corresponds to a corresponding drop in the voltage at the terminals of the battery. Other, less substantial voltage drops then occur during the phase of starting, and correspond to passages through successive top dead centres of the thermal engine.

The development of so-called “reinforced” starters, designed for systems for automatic stopping/restarting of the thermal engine (so-called stop/start or stop & go systems) is now making new demands on motor vehicle parts manufacturers relating to compliance with minimum voltage thresholds of the battery during the current requirement when power is supplied to the starter. Thus, in their specifications, motor vehicle manufacturers are defining a first voltage threshold which is habitually between 7 and 9 V, below which the battery voltage must not drop. For the following voltage drops, corresponding to the top dead centres of the thermal engine, the battery voltage must remain higher than a second voltage threshold, which is habitually between 8 and 9 V. During the starting of the thermal engine, the on-board network voltage of the vehicle thus remains at a value which is sufficient to guarantee the required functioning of the equipment of the vehicles.

Reinforced starters generally have power which is greater than conventional starters, such as to obtain rapid starting for increased comfort of the users. This results in a higher requirement for current when the power is switched on, and therefore to a first battery voltage drop which goes beyond the habitual values, and in relation to high requirements. This gives rise to a genuine difficulty for the manufacturer, since, in order to have a higher battery voltage, it would be necessary for the starter to have internal voltage drops so great that it would then no longer have the power necessary to drive the thermal engine at a sufficient speed at low temperature.

Solutions have been proposed to the above-described problems in the prior art. A known solution by the inventive body is based on the use of voltage-increasing electronic converters, in order to avoid an excessively low voltage level on the on-board network. A disadvantage of these converters consists of the substantial costs which they introduce.

The known solutions concern systems for electrical supply to the equipment of a motor vehicle substantially based on standard batteries of the 12 V lead-acid type.

However, these standard batteries are living on borrowed time, since, although they still benefit from dispensation from European regulations which limit the use of lead, there is no doubt that they will eventually be prohibited in vehicles.

Consequently, motor vehicle parts manufacturers are anticipating the generalisation of use of lead-free high-performance batteries, in particular of the lithium-ion type, to replace conventional batteries.

A lithium-ion type battery with nominal voltage close to that of a standard 12 V battery, comprising six lead elements each supplying charges of 2.25 V, must comprise four cells in series, with each charged cell having a voltage of 3.6 V.

Thus, a nominal operating voltage of a lithium-ion battery is 13.4 V, whereas that of a standard battery is 12.8 V.

In the case of use of equipment designed for a 12 V voltage with a battery of the lithium-ion type, it is found that the technical problem to be solved is no longer that of the aforementioned voltage drop, but rather that of the current requirement at the moment when power is supplied to the starter, which current requirement is made greater by the higher voltage applied and by the lower internal resistance of the lithium-ion type battery.

This problem has been clearly identified by the company PEUGEOT CITROEN AUTOMOBILES, which proposes a system for limitation of the current of a lithium-ion battery for a motor vehicle in international patent application WO2013/121133.

The solution proposed consists of use of low-value resistors in series with the starter, and also an alternator. These resistors are put into service by switches depending on the operating modes of these items of equipment.

This solution has a major disadvantage of decreasing the electrical performance of the electrical supply system, since substantial intensity passes through resistive elements: a 1 mΩ resistor through which 1000 A passes in order to decrease the voltage by 1 V dissipates power of 1 kW!

This solution also has other disadvantages, i.e.:

an additional cost of the active components constituted by the switches, relays or power semiconductors and their control devices, which is an extremely important factor in the highly competitive motor vehicle industry;

a relative lack of reliability caused by the use of semiconductor components and the use of electromechanical relays, with moving parts and springs which give rise to impacts;

electrical stress events (electromagnetic fields) on the on-board network, typically of a few kVs during mechanical switchings; and

a delay in the time for starting the thermal engine.

### GENERAL DESCRIPTION OF THE INVENTION

The objective of the present invention is thus to eliminate the disadvantages of the solution known in the prior art previously described, in order to permit replacement in motor vehicles of batteries of the lead-acid type by batteries of the lithium-ion type, without decreasing the performance, and with limitation of the additional costs.

The system for supplying electric power to the electrical equipment of a motor vehicle by a high-performance battery in question is of the type comprising at least one current limitation device of this high-performance battery, with a first nominal voltage, with specific characteristics of the equipment designed to be connected to a standard battery, and with a second nominal voltage lower than the first nominal voltage.

In the field of application of the invention, this equipment comprises at least one starter of a thermal engine of the vehicle, connected to the high-performance battery by a power circuit comprising a limitation device of this type fitted in series with the starter.

According to the invention, the limitation device is in particular a transformer comprising a secondary winding circuit formed by a short-circuited secondary winding.

This transformer has a coupling coefficient and a secondary resistance of the secondary winding circuit which depend on specific characteristics of the equipment.

According to the invention, a primary winding of the transformer is inserted between a power contact of an electromagnetic contactor, and an electric motor of the starter.

In the system for supplying electric power to the electrical equipment of a motor vehicle by a high-performance battery according to the invention, the equipment comprises a plurality of electric motors, each connected by a contactor and an example of the limitation device to an on-board network which is supplied by the high-performance battery.

According to the invention, this equipment additionally comprises at least one element of a group comprising at least one electric windscreen wiper, at least one at least one electric power window, at least one electric windscreen washer, at least one electric fan, at least one electric compressor, and at least one electric lock.

In the system for supplying electric power to the electrical equipment of a motor vehicle by a high-performance battery according to the invention, the high-performance battery is of the lithium-ion type with a first nominal voltage of approximately 13.4 V, and the standard battery is of the lead-acid type with a second nominal voltage of approximately 12.8 V.

The invention also relates to a device for limitation of the current of a high-performance battery which can be used in the system for supplying electric power to the electrical equipment of a motor vehicle by a high-performance battery previously described.

According to the invention, it comprises a magnetic circuit formed by a casing made of magnetic material comprising a cylindrical head, two closure parts, and an axial core around which a primary winding and a short-circuited secondary winding are arranged.

Also according to the invention, the secondary winding is formed by an electrically conductive tube which surrounds the primary winding, and has a ratio of length to radius which is predetermined according to specific characteristics of one of the items of equipment for which the limitation device is designed.

The invention also relates to a combination in a motor vehicle of a starter comprising an electric motor and an electromagnetic contactor, a high-performance battery of the lithium-ion type, and a device for limitation of the current of this high-performance battery previously described.

In this combination, according to the invention, the limitation device is secured on an outer housing of the starter, and the electric motor is a standard motor which is designed to be supplied with power by a standard battery of the lead-acid type.

These few essential specifications of the invention will have made apparent to persons skilled in the art the elimination of the disadvantages of the only solution known hitherto, which made possible replacement in motor vehicles of batteries of the lead-acid type by high-performance batteries, in particular of the lithium-ion type.

The detailed specifications of the invention are given in the description which follows in association with the appended drawings. It should be noted that these drawings serve the purpose simply of illustrating the text of the description, and do not constitute in any way a limitation of the scope of the invention.

### BRIEF DESCRIPTION OF THE DRAWINGS

FIG. 1 is a process diagram of a system for supplying electric power to the electrical equipment of a motor vehicle by a battery of the lithium-ion type known in the prior art.

FIG. 2 is a process diagram of a system for supplying electric power to the electrical equipment of a motor vehicle, in particular a starter, by a battery of the lithium-ion type according to the invention.

FIG. 3 is a process diagram of a system for supplying electric power to the electrical equipment of a motor vehicle, in particular a starter, and several other items of equipment comprising electric motors, by a battery of the lithium-ion type according to the invention.

FIG. 4 shows in axial cross-section an embodiment of a current limitation device of a high-performance battery, which device can be used in the system for supplying electric power to the electrical equipment of a motor vehicle, by a high-performance battery according to the process diagrams shown in FIGS. 2 and 3.

FIG. 5 is a schematic view showing a combination of a battery of the lithium-ion type, a standard starter, and a current limitation device of a high-performance battery according to the invention.

### DESCRIPTION OF PREFERRED EMBODIMENTS OF THE INVENTION

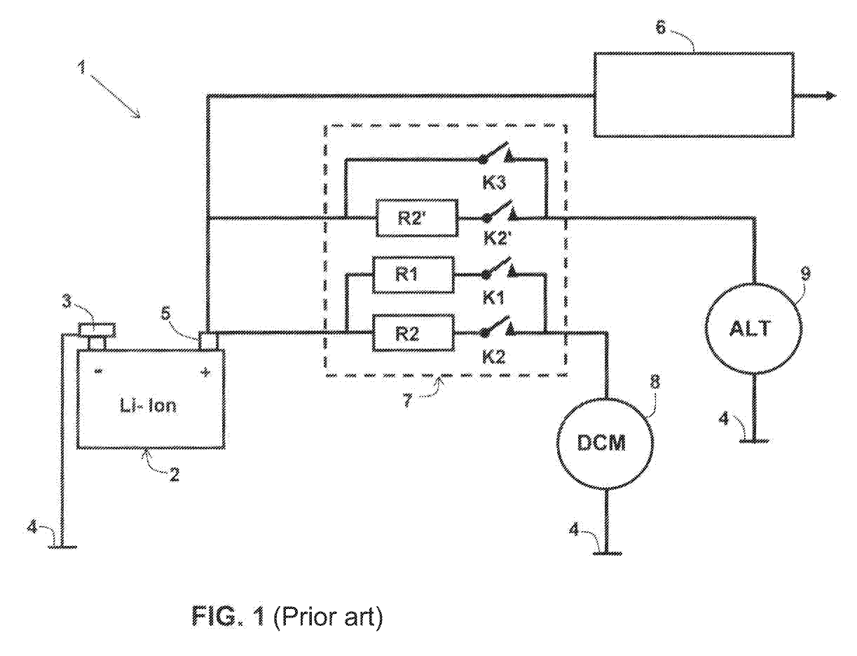

In the system 1 for supplying electric power to the electrical equipment of a motor vehicle known in the prior art represented in FIG. 1, a battery 2 with lithium-iron-phosphate (LiFePO₄) technology comprises a negative terminal 3 leading to an earth 4, and a positive terminal 5 which is connected to an on-board network 6 of the vehicle.

The positive terminal 5 of this battery 2 is also connected by an electrical circuit 7 to an electric motor DCM of a starter 8 of the thermal engine of the vehicle, and to an alternator 9 which is driven by this thermal engine.

The electrical circuit 7 comprises, between the positive terminal 5 of the battery 2 and the starter 8, a first connection comprising a first resistor R1 with a low value of approximately 1 mΩ, arranged in series with a first switch K1, and a second connection comprising a second resistor R2 of approximately 6 mΩ, arranged in series with a second switch K2.

The electrical circuit 7 comprises, between the positive terminal 5 of the battery 2 and the alternator 9, a third connection comprising only a third switch K3, and a fourth connection comprising another resistor R2′, also of approximately 6 mΩ, arranged in series with another switch K2′.

The switches K1, K2, K3, K2′ are controlled by control and command electronics which receive various information on the running of the vehicle and the actions of the driver.

For the starting of the thermal engine using the starter 8, the second switch K2 is closed, which makes it possible to lower a first nominal voltage of approximately 13.4 V supplied by the battery 2, to a second nominal voltage 12.8 V which is compatible with the characteristics of an electric motor 8 of a starter, designed to be connected to a standard battery of the lead-acid type.

Exceptionally, in difficult starting conditions, the first switch K1 is closed in order to supply the starter with a higher voltage.

Similarly, the third and fourth switches K2′, K3 are controlled according to the state of charge of the battery 2.

As already indicated in the preamble, this system 1 for supplying electric power to the electrical equipment of a motor vehicle known in the prior art is not satisfactory, since valuable electrical energy is dissipated to no advantage by Joule effect in the electrical circuit 7.

This is even more unsatisfactory if the electrical supply system 1 is used in an automatic stopping/restarting system, where restarting operations are very frequent in urban traffic.

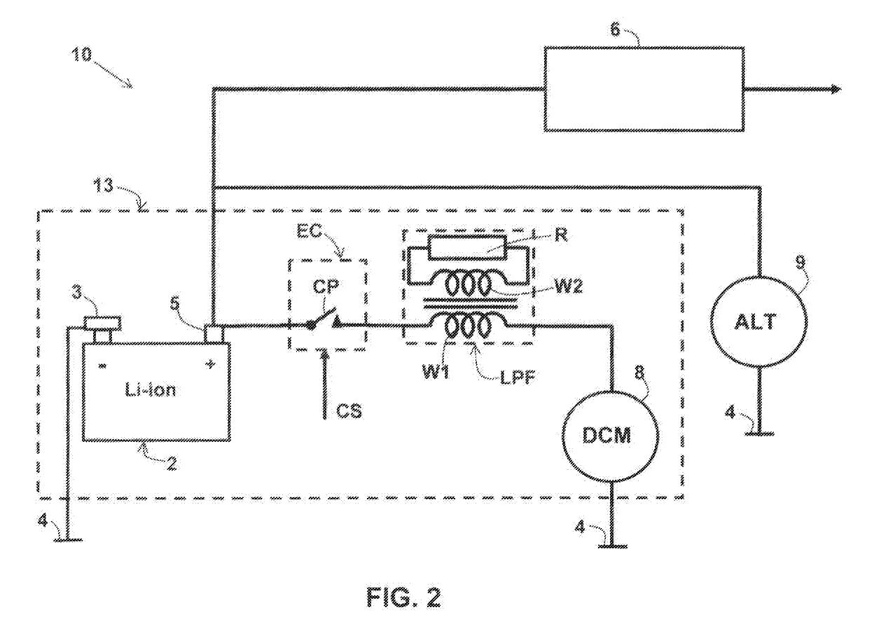

In the system 10 for supplying electric power to the electrical equipment of a motor vehicle according to the invention represented in FIG. 2, instantaneous power consumed by the electric motor DCM of the starter is limited by a device LPF for limitation of the current supplied by the lithium-iron battery 2, but the electrical energy is recuperated at least partly as a result of the inductive nature of this device LPF.

The limitation device LPF is inserted in a power circuit of the starter EC, DCM, in series between the electric motor DCM and a power contact CP of the electromagnetic contactor EC.

In this case, the contactor EC is a conventional starter contactor with a simple power contact CP, and comprises a solenoid formed by a pull-in coil and a hold-in coil.

Closure of a starter contact CS of the vehicle commands the excitation of the pull-in and hold-in coils, and activation of the starter DCM, EC, according to a sequence which is well-known by persons skilled in the art, and will not be described in detail here.

The strong initial current spike previously mentioned intervenes at the closure of the power contact CP, when the motor DCM is supplied with full power.

Closure of the power contact CP also gives rise to circulation in the limitation device LPF of a power current which supplies power to the motor DCM.

As shown in its wiring diagram in FIG. 2, the limitation device LPF is a transformer of the armoured type with windings W1, W2 which are coupled magnetically, and a secondary winding circuit W2, R, formed by a secondary winding W2, the ends of which are connected directly to one another, i.e. which is short-circuited.

Various embodiments of this transformer LPF make it possible to have several parameters in order to adjust the pulse response of the limitation device LPF, according to the specific characteristics of the electric motor DCM of the starter. Thus, it is possible to optimise this response by regulating inductances of the primary and secondary windings W1, W2, by mutual inductance introduced by coupling between these circuits, and by a secondary resistor of the secondary winding circuit R, W2 represented in FIG. 2 by an equivalent resistor R.

However, the transformer LPF continues to be a high-quality transformer, i.e. it is selected so as to have a coupling coefficient close to a unit.

It will be remembered that the coupling coefficient of a transformer is defined by the ratio k=M/(L₁·L₂)^{1/2}, where M is a mutual inductance, L₁ is the primary inductance, and L₂ is the secondary inductance.

The primary winding circuit W1 is the one which is inserted in the power circuit of the starter.

Typically, an equivalent inductance of the limitation device LPF is between 0.1 and 10 mH approximately for power currents with an order of magnitude of 300 to 1000 A.

The effect of limitation of the instantaneous power is derived from the fact that when power is supplied to the motor DCM by the lithium-ion battery 2, the initial current spike is attenuated by approximately half despite a supply voltage which is higher than that supplied by a standard lead battery, because of the production of strong induced currents in the short-circuited secondary circuit W2, which opposes the sudden variation of magnetic flux which generates them.

Slow development of the power current at the moment when power is supplied to the motor DCM limits the risks of electrical damage to the brush-collector contacts of the motor DCM, and attenuation of the initial current spike limits the risks of mechanical damage caused by an associated excessively high level of torque.

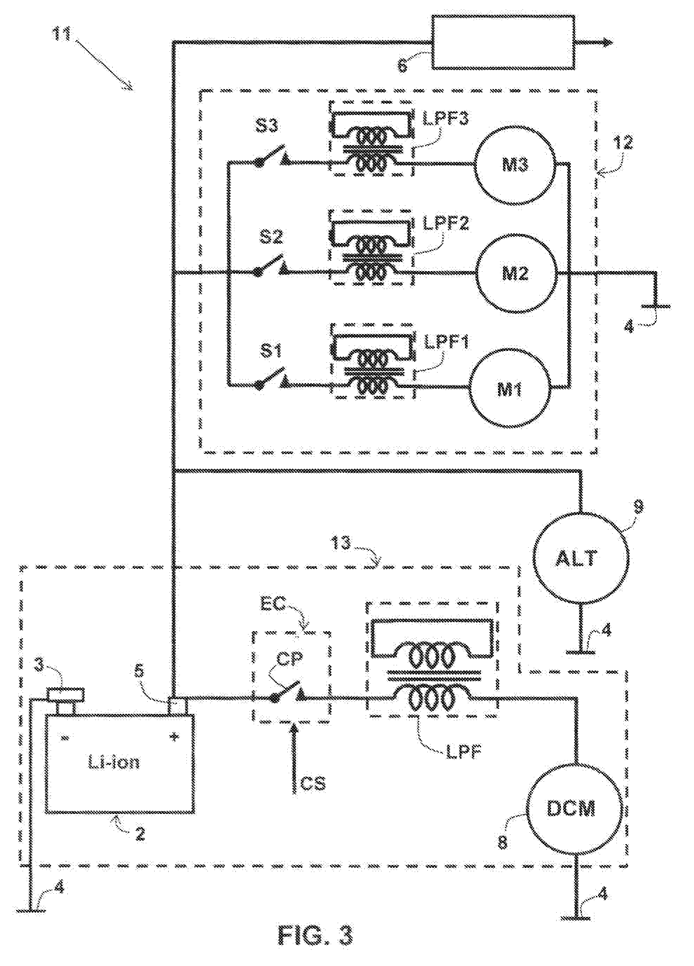

In the system 11 for supplying electric power to the electrical equipment of a motor vehicle according to the invention represented in FIG. 3, electric motors M1, M2, M3 of equipment 12 designed to function with a standard 12 V battery are put into operation by switches S1, S2, S3, by connecting them to the lithium-ion battery 2.

Current limiters LPF1, LPF2, LPF3 according to the invention, of the same type as the one previously described, formed by transformers with a short-circuited secondary, are inserted in series with these electric motors M1, M2, M3.

These transformers are adapted to the characteristics of the equipment, which can be an electric windscreen wiper, an electric power window, an electric windscreen washer, an electric fan, an electric compressor, or an electric lock.

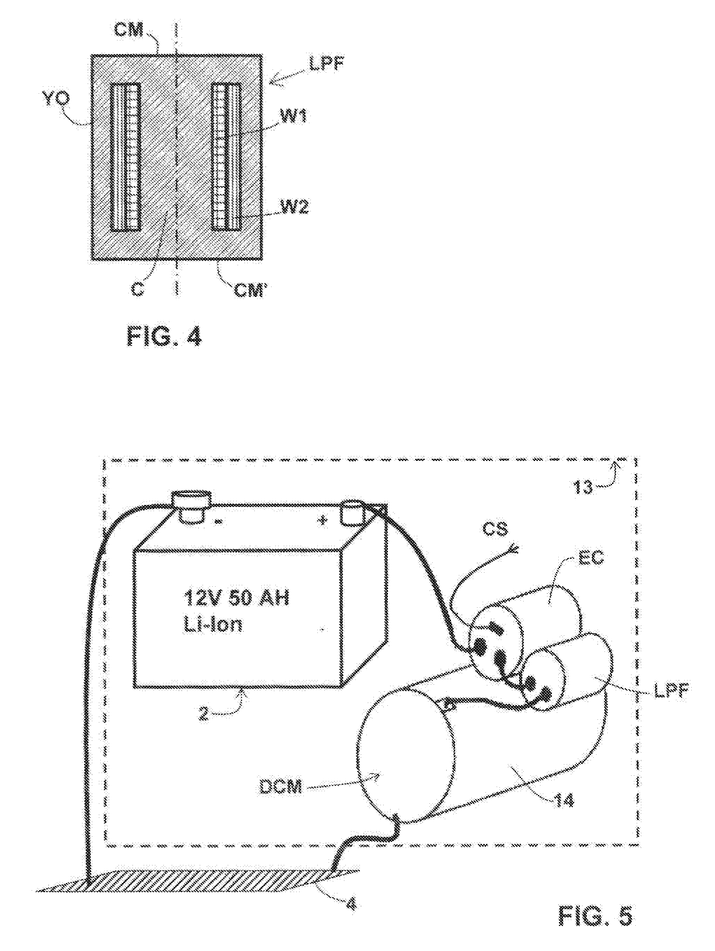

An example of a specific embodiment of the current limitation devices LPF, LPF1, LPF2, LPF3 is shown in FIG. 4.

In the example in FIG. 4, the transformer LPF substantially comprises a casing C, YO, CM, CM′ made of magnetic material such as steel, and primary W1 and secondary W2 windings.

The casing comprises a cylindrical head YO, two closure parts CM. CM′ and an axial core C, around which the primary and secondary windings W1, W2 are arranged.

The primary winding W1 is designed to be inserted in series in the power circuit DCM, EC, and the secondary winding W2 is short-circuited.

This secondary winding W2, which surrounds the primary winding W1, comprises a plurality of turns, or alternatively it is produced in the form of an electrically conductive tube.

In an embodiment in the form of a tube, the latter has a ratio of length to radius which is predetermined according to specific characteristics of the equipment for which the limitation device LPF is designed.

FIG. 5 shows schematically a specific application of a limitation device LPF according to the invention in a motor vehicle.

The application presented relates to a combination 13 of:

a lithium-ion battery 2 of a 12 V 50 Ah model;

a starter DCM, EC comprising a direct current electric motor DCM and an electromagnetic contactor EC designed for use with a standard 12 V lead-acid battery;

a current limitation device LPF as previously described.

In this application, the current limitation device LPF is secured mechanically on an exterior housing 14 of the electric motor DCM of the starter, in the vicinity of the contactor EC.

The electrical connections between the current limitation device LPF, the contactor EC and the electric motor DCM correspond to the process diagram shown in FIG. 2.

The current limitation device LPF according to the invention is an entirely passive device which does not need any complex control logic, necessarily generating substantial additional costs, unlike the electrical circuit 7 formed by switchable resistors R1, R2, R2′ known in the prior art, as shown in FIG. 1.

Since the current limitation is not based on the insertion of resistors R1, R2, R2′, nor are there associated losses by Joule effect, and the electrical performance of the supply system 10, 11 is maintained.

It will be appreciated that the invention is not limited simply to the above-described preferred embodiments. Also, the equipment cited consists only of non-limiting examples: any equipment of the vehicle which constitutes an inductive or capacitive load which can give rise to a high requirement for current when power is supplied to it can be protected by the current limitation device LPF according to the invention.

The high-performance battery 2 cited is a battery of the lithium-ion type with iron-phosphate technology. A battery 2 with iron-phosphate technology doped with yttrium (LiFeYPO₄) operating at lower negative temperatures (down to −35° C.) could equally well be implemented in the electrical supply system 10, 11 according to the invention, as well as batteries with other technologies such as lithium-cobalt oxide (LiCoO₂), lithium-manganese oxide (LiMn₂O₄), lithium-nickel-manganese-cobalt oxide (LiNiMnCoO₂), lithium-nickel-manganese-aluminium oxide (LiNiMnAlO₂), lithium-titanate (Li₄Ti₅O₁₂, with five elements in series).

High-performance batteries of the lithium-polymer (Li—Po) type can also be envisaged for motor vehicle applications. With a voltage per element of 3.7 V, they differ little from iron-phosphate batteries with a voltage per element of 3.6 V. Thanks to the present invention, a standard 12 V lead battery could also be replaced in a vehicle by a Li—Po battery 2 with four elements, without damage to the equipment.

The invention thus incorporates all possible variant embodiments, within the limits of the subject of the following claims.

1. System (1, 10, 11) for supplying electric power to the electrical equipment (6, 8, 9, 12) of a motor vehicle by a so-called high-performance battery (2) of the type comprising at least one limitation device (7, LPF), in order to limit a current of said high-performance battery (2), with a first nominal voltage, in order to satisfy characteristics of said equipment (6, 8, 9, 12) initially designed to be connected to a so-called standard battery, with a second nominal voltage lower than said first nominal voltage, said equipment (6, 8, 9, 12) comprising at least one starter (8) of a thermal engine of said vehicle, connected to said high-performance battery (2) by a power circuit comprising said at least one limitation device (7, LPF) fitted in series with said starter (8), wherein said at least one limitation device (LPF) is a transformer comprising a secondary winding circuit (R, W2) formed by a short-circuited secondary winding (W2).

2. System (10, 11) for supplying electric power to the electrical equipment (6, 8, 9, 12) of a motor vehicle by a so-called high-performance battery (2) according to claim 1, wherein said transformer (LPF) has a coupling coefficient and a secondary resistance (R) of said secondary winding circuit (R, W2) which depend on said characteristics.

3. System (10, 11) for supplying electric power to the electrical equipment (6, 8, 9, 12) of a motor vehicle by a so-called high-performance battery (2) according to claim 1, wherein a primary winding (W1) of said transformer (LPF) is inserted between a power contact (CP) of an electromagnetic contactor (EC), and an electric motor (DCM) of said starter (EC, DCM).

4. System (10, 11) for supplying electric power to the electrical equipment (6, 8, 9, 12) of a motor vehicle by a so-called high-performance battery (2) according to claim 1, wherein said equipment (6, 8, 9, 12) comprises a plurality of electric motors (M1, M2, M3) each connected by a contactor (S1, S2, S3) and by a so-called limitation device (LPF) to an on-board network which is supplied by said high-performance battery (2).

5. System (10, 11) for supplying electric power to the electrical equipment (6, 8, 9, 12) of a motor vehicle by a so-called high-performance battery (2) according to claim 4, wherein said equipment (6, 8, 9, 12) additionally comprises at least one element of a group comprising at least one electric windscreen wiper, at least one at least one electric power window, at least one electric windscreen washer, at least one electric fan, at least one electric compressor, and at least one electric lock.

6. System (10, 11) for supplying electric power to the electrical equipment (6, 8, 9, 12) of a motor vehicle by a so-called high-performance battery (2) according to claim 1, wherein said high-performance battery (2) is of the lithium-ion type with a first nominal voltage of approximately 13.4 V, and said standard battery is of the lead-acid type with a second nominal voltage of approximately 12.8 V.

7. Device (LPF) for limitation of the current of a high-performance battery (2) which can be used in the system (10, 11) for supplying electric power to the electrical equipment (6, 8, 9, 12) of a motor vehicle by a so-called high-performance battery (2) according to claim 1, comprising a magnetic circuit (YO, C, CM, CM′) formed by a casing (YO, C) made of magnetic material comprising a cylindrical head (YO), two closure parts (CM, CM′), and an axial core (C) around which a primary winding (W1) and a short-circuited secondary winding (W2) are arranged.

8. Device (LPF) for limitation of the current of a high-performance battery (2) according to claim 7, wherein said secondary winding (W2) is formed by an electrically conductive tube which surrounds said primary winding (W1), and has a ratio of length to radius which is predetermined according to specific characteristics of one of the items of electrical equipment (6, 8, 9, 12) for which said limitation device is designed.

9. Combination (13) in a motor vehicle of a starter (DCM, EC) comprising an electric motor (DCM) and an electromagnetic contactor (EC), a high-performance battery (2) of the lithium-ion type, and a device (LPF) for limitation of the current of said high-performance battery (2) according to claim 7.

10. Combination (13) according to claim 9, wherein said limitation device (LPF) is secured on an outer housing (14) of said starter (DCM, EC), and wherein said electric motor (DCM) is a standard motor which is designed to be supplied with power by a standard battery of the lead-acid type.

11. System (10, 11) for supplying electric power to the electrical equipment (6, 8, 9, 12) of a motor vehicle by a so-called high-performance battery (2) according to claim 2, wherein a primary winding (W1) of said transformer (LPF) is inserted between a power contact (CP) of an electromagnetic contactor (EC), and an electric motor (DCM) of said starter (EC, DCM).

12. System (10, 11) for supplying electric power to the electrical equipment (6, 8, 9, 12) of a motor vehicle by a so-called high-performance battery (2) according to claim 2, wherein said equipment (6, 8, 9, 12) comprises a plurality of electric motors (M1, M2, M3) each connected by a contactor (S1, S2, S3) and by a so-called limitation device (LPF) to an on-board network which is supplied by said high-performance battery (2).

13. System (10, 11) for supplying electric power to the electrical equipment (6, 8, 9, 12) of a motor vehicle by a so-called high-performance battery (2) according to claim 2, wherein said high-performance battery (2) is of the lithium-ion type with a first nominal voltage of approximately 13.4 V, and said standard battery is of the lead-acid type with a second nominal voltage of approximately 12.8 V.

14. System (10, 11) for supplying electric power to the electrical equipment (6, 8, 9, 12) of a motor vehicle by a so-called high-performance battery (2) according to claim 3, wherein said high-performance battery (2) is of the lithium-ion type with a first nominal voltage of approximately 13.4 V, and said standard battery is of the lead-acid type with a second nominal voltage of approximately 12.8 V.

15. System (10, 11) for supplying electric power to the electrical equipment (6, 8, 9, 12) of a motor vehicle by a so-called high-performance battery (2) according to claim 4, wherein said high-performance battery (2) is of the lithium-ion type with a first nominal voltage of approximately 13.4 V, and said standard battery is of the lead-acid type with a second nominal voltage of approximately 12.8 V.

16. System (10, 11) for supplying electric power to the electrical equipment (6, 8, 9, 12) of a motor vehicle by a so-called high-performance battery (2) according to claim 5, wherein said high-performance battery (2) is of the lithium-ion type with a first nominal voltage of approximately 13.4 V, and said standard battery is of the lead-acid type with a second nominal voltage of approximately 12.8 V.
